(19) United States
(12) Patent Application Publication
(10) Pub. No.: US 2013/0206165 A1
(43) Pub. Date: Aug. 15, 2013

(54) Damage Free Cleaning Using Narrow Band Megasonic Cleaning

(71) Applicants: Ahmed Busnaina, Needham, MA (US); Pegah Karimi, Allston, MA (US); Jingoo Park, Newton, MA (US)

(72) Inventors: Ahmed Busnaina, Needham, MA (US); Pegah Karimi, Allston, MA (US); Jingoo Park, Newton, MA (US)

(21) Appl. No.: 13/582,326

(22) PCT Filed: Mar. 3, 2011
(86) PCT No.: PCT/US11/26977

§ 371 Date: Apr. 16, 2013

Related U.S. Application Data
(60) Provisional application No. 61/310,028, filed on Mar. 3, 2010.

(51) Int. Cl. B08B 3/12

(52) U.S. Cl. CPC B08B 3/12
USPC 134/1.3; 134/184

(57) ABSTRACT

This invention relates to apparatuses and methods for cleaning surfaces, including the surfaces of semiconductor wafers, with ultrasonic and megasonic energies of defined profiles, capable of achieving said cleaning without causing damage to nanodimensioned features of the substrates.

### CROSS-REFERENCE TO RELATED APPLICATIONS

This application claims the benefit of U.S. Patent Application Ser. No. 61/310,028 filed Mar. 3, 2010, which is incorporated by reference herein in its entirety.

### TECHNICAL FIELD

This invention relates to apparatuses and methods for cleaning substrates, including functionalized semiconductor wafers, with megasonic energy, using defined energy profiles which allows cleaning without causing damage to nanodimensioned features of the substrates.

### BACKGROUND

In semiconductor wafer substrate (wafer) cleaning, particle removal is essential. Particles arising from metal or dielectric deposition or etching, or photoresist processing all provide opportunities for electrical or physical defects. The cleaning of submicron deep trenches and vias presents a particular challenge in semiconductor manufacturing. A particle that exceeds ¼ of the minimum feature size can potentially cause fatal device defects, and as feature sizes continue to become smaller, technologies to remove smaller and smaller particles are required. At the same time, decreasingly smaller devices/features are more susceptible to damage from cleaning technologies.

One means of removing such particles, includes: the use of an ultrasonic cleaning device, which uses high frequency soundwaves (typically in the range 40 Hz to 1 MHz) transmitted through liquids. The application of sonic energy approaching and exceeding one megahertz is often referred to as megasonic processing. These higher frequencies are used in an attempt to dislodge smaller contaminant particles and to reduce the localized energy release associated with cavitation (and microcavitation), as has been observed with lower frequency ultrasonic cleaners.

Typically, a megasonic cleaning device uses a process in which a wafer is placed in a liquid bath and megasonic irradiation (sometimes called cavitation; see U.S. Pat. No. 7,190,103) is applied to the liquid in the bath. The megasonic frequencies are produced by piezoelectric transducers coupled with a transmitter or resonator. In some arrangements, fluid enters the wet processing chamber from the bottom or side of the tank and overflows from the top or other end of the tank, thereby flushing the loosened particles from the tank by overflow. In some cases, chemicals in the liquid provide a slight surface etching and provide a surface termination, such that the dislodged particles are not re-deposited on the surface.

Despite the theoretical predictions that megasonic cleaning should not result in damage to fine features on the substrates (see e.g., Puskas, U.S. Pat. No. 5,834,871 (“because the energy in each cavitation decreases with increasing frequency, damages due to [ultrasonic] cavitation implosion have been reduced or eliminated [in megasonic cleaning]”, cal. 6, lines 39-42)), such damage persists (especially in commercially available megasonic cleaning devices) and a range of strategies have been developed to avoid this damage. In particular, many researchers have clearly shown damage attributable to cavitation damage at megasonic frequencies.

For example, US. Pat. No. 5,834,871 (“Puskas '871”) discusses in depth the problems of “operat[ing] an ultrasonic transducer at a fixed, single frequency because of the resonances created at that frequency” (col. 10, lines 37,40), or the desirability of eliminating or avoiding “the standing waves created by the resonances within the liquid [resulting from single frequency sound (or narrow band ultrasound)]” (col. 4, lines 35-42). Accordingly, Puskas teaches varying sweep rates so as to eliminate resonances which are created by transducers operating within a single sweep rate.

Explanations for the damage seen under megasonic cleaning are described in terms of microcavitation or microstreaming. See also Montierth, et al., (U.S. Pat. No. 7,238,085) (“Montierth '085”) (“Examples of megasonic processing damage may be seen with fragile polysilicon lines . . . This damage may be caused by cavitation, microcavitation, microstreaming, or even just the pressure waves traveling through fluid impinging on the surface of the substrate, or on the polysilicon lines directly, depending on conditions and method of introduction of sonic energy to the processing vessel.” col. (Id., col. 8, lines 42-51)).

Various conflicting sources describe that the use of higher megasonic frequencies improve cleaning performance, while others that such higher frequencies do not See e.g., Puskas (U.S. Pat. Nos. 5,834,871, and 6,946,773) (increasingly higher-frequencies do not necessarily improve the cleaning of sub-micronparticles).

Others attribute damage to the power of megasonic energy. It is “known” that at megasonic frequencies there is a tradeoff between cleaning efficiency and possible damage to structures as power (intensity) is increased. For example, Bran et al. (U.S. Pat. Nos. 6,679,272 and 6,892,738) describes that extent of damage is directly proportional to the power, or sonic watt density applied to the probe. (col. 1, line 66col. 2, line 6). Nickhou, et al.'s U.S. Pat. No. 6,866,051 describes problems with batch substrate cleaners as resulting from “shadowing” and “hot spots” within the cleaners, resulting from the reflection and/or constructive interference of megasonic energy, and is compounded with the additional substrate surface area of multiple substrates. According to Nickhou, these problems can be avoided by using higher energies, but doing so lends to damage the substrates. (col. 1, lines 30-57). Moving or rotating substrates or use of acoustic lenses within the tank helps with uniformity of cleaning and avoiding concentration of energy is in specific areas of the substrate. See U.S. Pat. Nos. 5,834,871; 6,679,272; 6,882,087; 6,892,738; and 6,946,773.

Montierth, et al., (U.S. Pat. No. 7,238,085) describes strategies using alternative megasonic fluid types, introduction of microbubbles, and processing at elevated/reduced pressure or temperature conditions, alone or in combination, to reduce the damage imparted to substrate features during megasonic processing (col. 86, lines 3-9). A similar study reported by A. Lippert, P. Engesser, A. Gleissner, M. Koffler, F. Kumnig, R. Obweger, A. Pfeuffer, R. Rogatschnig and H. Okorn-Schmidt, Journal of the Electrochem. Soc., vol. 01-03, 158, 2005, using 90 nm polysilicon-line structures on 200 mm wafers using megasonic cleaning at 1 MHz correlated power of the megasonic sound field, the amount of dissolved gas, size of gas bubbles, process temperature and the ratio of the ammonia peroxide mixture have different influences on the process results. One of the most significant influences on the cleaning and damage process resulted from the bubble distribution (the amount of bubbles in the active megasonic field) and the size distribution of stimulated gas bubbles, consistent with a cavitation (or microcavitation) mechanism.

Bran, et al. (U.S. Pat. Nos. 6,679,272 and 6,892,738) identified potential problems with directionality of the impingement of megasonic beams on fragile structures, and devised methods and equipment for directionally applying these megasonic beams to be oblique to these structures. The megasonic transmitters are applied proximate, yet at angles other than 90°, to the substrate, so as to reduce absolute power to each wafer, in order to affect cleaning without damage. Montierth, et al., (U.S. Pat. No. 7,238,085) also describes the need to fix the angle of incidence of the megasonic energy to the substrate to within a critical range of incidence angles.

There is still a need for megasonic cleaners which uniformly remove nanometer and micron scale particulates from semiconductor substrates without causing damage to nanodimensioned structures.

### SUMMARY

The present invention features apparatuses and the methods for cleaning surfaces, including surfaces of semi-conductor substrates, microelectronic substrates, nanodimensioned substrates, nanostructured substrates, or other similar articles, with megasonic energy without causing damage to nanodimensioned features of the substrates. The inventors have discovered that damage previously attributable to microcavitation can be eliminated by use of narrow bandwidth transducers. Such transducers have never been applied to megasonic cleaning of semiconductor substrates, and as such represents a significant improvement to the art of megasonic cleaning.

Embodiments of this invention include defining the delivered frequencies in various frequency ranges, thereby maximizing cleaning uniformity and efficiencies while minimizing damage. Other embodiments describe that by so defining these delivered frequencies, it is also possible to get uniform cleaning within a cleaning apparatus at high powers without said damage.

One series of embodiments define an apparatus for cleaning surfaces comprising at least one narrow bandwidth megasonic transducer, said transducer providing a power amplitude of at least −50 dBV at a maximum amplitude megasonic frequency of at least 400 kHz and providing power amplitudes less than −55 dBV over a low frequency band between 20 and 360 kHz. Various additional embodiments based on this apparatus further define the maximum amplitude megasonic frequency, the amplitude of this frequency, the low frequency band, the amplitude of the low frequency band, and the ratio of the amplitudes of the megasonic amplitude to the low frequency amplitudes.

Another series of embodiments describe an apparatus for cleaning surfaces comprising at least one narrow bandwidth megasonic transducer, said apparatus exhibiting a maximum delivered power amplitude of at least −50 dBV at megasonic frequency of at least 400 kHz and power amplitudes less than −55 dBV over a low frequency band of 20-360 kHz. Various additional embodiments based on this apparatus further define the maximum amplitude megasonic frequency, the amplitude of this frequency, the low frequency band, the amplitude of the low frequency band, and the ratio of the amplitudes of the megasonic amplitude to the low frequency amplitudes.

A third series of embodiments describe methods of cleaning surfaces using any one of the apparatuses or using the conditions previously described, wherein the megasonic energy is transmitted through an aqueous, organic, or mixed aqueous-organic solvent system, with or without additional cleaning chemistries, and at least 20% of the surface debris is removed.

Other embodiments provide that the method of cleaning is adapted to cleaning surfaces of semi-conductor substrates, microelectronic substrates, nanodimensioned substrates, nanostructured substrates, or other similar articles, including those surfaces optionally containing micron-scaled or nano-scaled channels. Those articles containing features which are otherwise prone to damage from ultrasonic cleaning are especially suited to this present method of cleaning. Still other embodiments describe these substrates as comprising nano-dimensioned structures, and the ability to clean the substrate surfaces without damaging these structures.

### BRIEF DESCRIPTION OF THE DRAWINGS

FIG. 1A is a picture of the PCT's NPPD8 megasonic tank; FIG. 1B shows the schema of PCT's NPPD8 megasonic tank.

FIG. 2A illustrates the layout of the 16 transducers in the traditional megasonic tank.

FIG. 2B shows the megasonic tank geometry.

FIG. 3 shows the power as a function of frequency for the traditional megasonic transducer, where the probe was placed ½ inch above the bottom of the tank and 6 inches far from the transducer which is on bottom of the tank and on top of the active transducer (transducer #1 and on top of one end of transducer).

FIG. 4 shows the power as a function of frequency for the traditional megasonic transducer, where the probe was placed ½ inch above the bottom of the tank and on top of the active transducer (transducer #1 and on top of one end of transducer)

FIG. 5 shows the power as a function of frequency for the traditional megasonic transducer, where the probe was placed ½ inch above the bottom of the tank and on top of transducer which is active (transducer #4)

FIG. 6 shows the power as a function of frequency for the traditional megasonic transducer, where the probe was placed 1 inch above the bottom of the tank on transducer 3 which is active

FIG. 7 shows the power as a function of frequency for the narrow bandwidth transducer.

FIG. 8 shows the SEM Images of silicon trenches used in this work: AA=200 nm; 2AB500 nm; AC=800 nm; and AD=2 micron.

FIG. 9 illustrates the technique of depositing particles in a trench using a dip coater.

FIG. 10 illustrates the removal efficiency vs. power for 100 nm PSL particles.

FIG. 11 illustrates the removal efficiency vs. power for 100 nm aged PSL particles.

FIG. 12 illustrates the removal efficiency vs. power for 600 nm silicon nitride particles.

FIG. 13 illustrates the removal efficiency vs. power for 300 nm silicon nitride particles.

FIG. 14 illustrates the construction of the walls used in the damage experiments.

FIG. 15 shows SEM images of 120 nm (A and C) and 150 nm (B and D) lines after cleaning with 30% power for 5 minutes. While the single wafer megasonic tank damages the structures the narrow bandwidth transducer preserves the patterns.

FIG. 16 shows SEM images of 130 nm (A and C) and 150 nm (B and D) lines after cleaning with 50% power for 5 minutes. While the single wafer megasonic tank damages the structures the narrow bandwidth transducer shows no damage.

FIG. 17 shows SEM images of 120 nm (A and C) and 150 nm (B and D) lines after cleaning with 70% power for 5 minutes.

FIG. 18 shows SEM images of 120 nm (A and C) and 150 nm (B and D) lines after cleaning with 100% power for 5 minutes for traditional and narrow bandwidth megasonic cleaning.

FIG. 19 shows SEM images of 120 nm (A and. C) and 350 nm (B and D) lines after cleaning with 100% power for 5 minutes.

### DETAILED DESCRIPTION OF ILLUSTRATIVE EMBODIMENTS

The present invention maybe understood more readily by reference to the following detailed description taken in connection with the accompanying Figures and Examples, which form a part of this disclosure. It is to be understood that this invention is not limited to the specific products, methods, conditions or parameters described and/or shown herein and that the terminology used herein is for the purpose of describing particular embodiments by way of example only and is not intended to be limiting of any claimed invention. Similarly, any description as to a possible mechanism or mode of action or reason for improvement is meant to be illustrative only, and the invention herein is not to be constrained by the correctness or incorrectness of any such suggested mechanism or mode of action or reason for improvement. Throughout this text, it is recognized that the descriptions refer both to the method of preparing such devices and to the resulting, corresponding physical devices themselves, as well as the referenced and readily apparent applications for such devices.

In the present disclosure the singular forms “a,” “an,” and “the” include the plural reference, and reference to a particular numerical value includes at least that particular value, unless the context clearly indicates otherwise. Thus, for example, a reference to “a material” is a reference to at least one of such materials and equivalents thereof known to those skilled in the art, and so forth.

When values are expressed as approximations, by use of the antecedent “about” it will be understood that the particular value forms another embodiment. In general, use of the term “about” indicates approximations that can vary depending on the desired properties sought to be obtained by the disclosed subject matter and is to be interpreted in the specific context in which it is used, based on its function, and the person skilled in the art will be able to interpret it as such. Where present, all ranges are inclusive and combinable.

It is to be appreciated that certain features of the invention which are, for clarity, described herein in the context of separate embodiments, may also be provided in combination in a single embodiment. Conversely, various features of the invention that are, for brevity, described in the context of a single embodiment, may also be provided separately or in any subcombination. Further, reference to values stated in ranges include each and every value within that range.

Generally terms are to be given their plain and ordinary meaning such as understood by those skilled in the art, in the context in which they arise. To avoid any ambiguity, however, several terms are described herein.

The term “ultrasonic” carries its traditional meaning, that being having a frequency beyond the normal range of human hearing, typically above 20 kHz.

The term “megasonic” typically refers to ultrasonic frequencies in the range of 0.5 to 2.5 MHz. However, as used herein, the lower end of the frequency range is extended, such that “megasonic” or “megasonic frequencies” refer, to frequencies in the range of 360 kHz to 2.5 MHz.

As used herein, the term “nano-” as in “nano-dimensioned,” “nano-scale,” or “nano-structured” refers to a dimension, scale, or structure having at least one dimension in the range of 0.5 to 1000 nm, preferably 1 to 500 nm, more preferably 5 to 350 nm, more preferably 5 to 250 nm, still more preferably 10 to 100 nm; i.e., having a dimension in the range independently bounded at the lower end by 0.5, 1, 5, 10, 15, 20, 25, 50, 75, 100, 250, or 500 nm and at the upper end by 1000, 750, 500, 350, 250, 150, 100, 50, 25, and 10 nm. Non-limiting exemplary ranges, for example, include 5-50 nm, 50-100 nm, 100-350 nm, 75-500 nm, or 500-1000 nm.

The present invention features apparatuses and methods for cleaning surfaces using megasonic energy. The term “traditional megasonic” refers to state-of-the art commercially available equipment, systems, and cleaning methods, as being representative of the art. It is generally distinguished from the present invention in that traditional megasonic systems do not control the amplitudes at low frequencies.

In one embodiment, the invention describes an apparatus for cleaning surface debris from a surface comprising at least one narrow bandwidth megasonic transducer, said transducer providing a power amplitude of at least −50 dBV at a maximum amplitude megasonic frequency of at least 400 kHz while providing power amplitudes less than −55 dBV over a band of low frequency band between 20 and 360 kHz.

While the descriptions used throughout this specification are given in terms of semiconductor wafers, the skilled artisan will appreciate that the apparatus is not restricted to cleaning such parts. That is, in certain embodiments, the apparatus is adapted for cleaning surfaces of semiconductor substrates, microelectronic substrates, nano-dimensioned substrates, nano-structured substrates, or other similar articles. Those articles containing features which are otherwise prone to damage from ultrasonic cleaning are especially suited for this technology.

Such an apparatus may be configured so as to allow cleaning either single or multiple (or both) substrates.

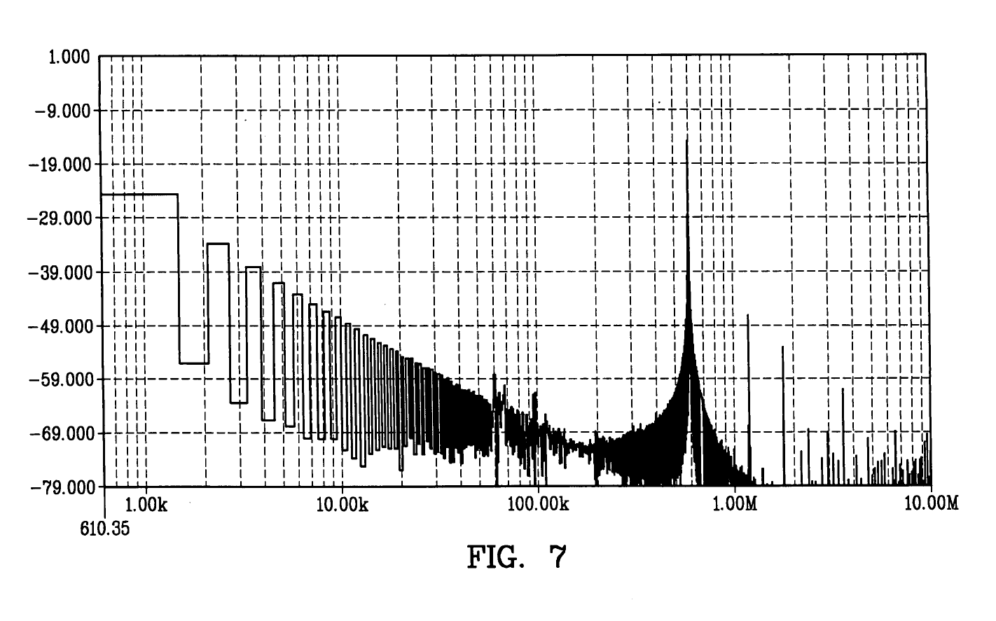

The term “maximum amplitude megasonic frequency” refers to the frequency at which the nominal megasonic frequency exhibits an amplitude maximum. By way of one non-limiting example, the maximum amplitude megasonic frequency in FIG. 7 is 600 kHz. In certain other separate embodiments, the narrow bandwidth transducer of this apparatus has a maximum amplitude megasonic frequency of at least 450 kHz, at least 500 kHz, at least 550 kHz, at least 600 kHz, at least 650 kHz, at least 700 kHz, at least 750 kHz, at least 800 kHz, at least 850 kHz, at least 900 kHz, at least 950 kHz, or at least 1000 kHz.

Such a transducer is typically made to allow, for variable input power control. The amplitudes associated with these narrow bandwidth megasonic transducers, in certain embodiments, can be at least −45 dBV at the maximum amplitude megasonic frequency, at least −40 dBV, at least −35 dBV, at least −30 dBV, at least −25 dBV, at least −20 dBV, at least −15 dBV, or at least −10 dBV, while maintaining the low amplitudes at the lower frequency band. It is appreciated that the “−dBV” scale is a logarithmic scale, and that larger numbers correspond to smaller values. For example, −30 dBV is larger than −40 dBV, which in turn is larger than −60 dBV.

The term “narrow bandwidth” can be used to describe transducers where substantially all of the power provided by the transducer is delivered in the megasonic frequency range; i.e., where the amplitudes delivered below the megasonic frequency range are significantly lower than in traditional megasonic cleaning transducers. One way a achieving the claimed profiles is through the use of commercially available narrow bandwidth transducers. These have never been applied to megasonic tank cleaning, and despite the long-seen problems or damage seen with megasonic cleaning, have never before been considered for this purpose. More typically, such narrow bandwidth transducers are used in acoustical sensing. One source for such a narrow band transducer is RESON (Goleta, Calif.). These narrow bandwidth transducers are typically characterized as exhibiting narrow directionally applied high frequency cone angles, which makes them especially suited for use as hydrographic echo sounders and/or in acoustical sensing. See, for example, the product specifications for RESON's TC2127 (600 kHz), TC3027 (1 KHz); and TC3021 (2 MHz) available at http://www.reson.com/sw244.asp, which are incorporated by reference herein for all purposes.

Another way of achieving the claimed delivered frequency profiles is to use active noise (frequency) cancellation technology opposite the low frequencies (i.e., sub-megasonic frequencies) generated by existing megasonic transducers, for example, analogous to active noise technologies used in stereo headsets or automotive engines.

The use of a secondary vibration damping system, such as used in conventional systems, may also be employed in conjunction with either narrow-band frequency generating device or technology.

In defining the low frequency (i.e., sub-megasonic frequency) range, various embodiments describe this low frequency band as being 20 to 360 kHz, 20 to 200 kHz, 20 to 100 kHz, 60 to 110 kHz, or more generally within a range independently bounded at the lower end by 20, 40, 60, 80, 100, 120, or 150 kHz; and at the upper end by 360, 310, 260, 210, 160, or 110 kHz.

It is believed that frequencies at the lower end of this range are responsible for damage associated with cavitation, though the invention is not so limited. The invention teaches that, within each of the ranges of interest, the transducer(s) provides power amplitudes at these low frequencies to −55 dBV or less, to −60 dBV or less, to −65 dBV or less, or to −70 dBV or less. Embodiments which include these amplitudes also include the various permutations of the various maximum amplitude megasonic frequencies and their corresponding amplitudes.

In separate embodiments, the transducer delivers different levels of power to the megasonic range and the low frequency band. In one measure of this difference, a power ratio is defined, wherein the ratio of deliverable decibel amplitudes, measured in −dBV, of the maximum megasonic frequency to the mean decibel amplitude, also measured −dBV, over the frequency range 20-100 kHz is 1/2 or less. For example, referring to Table 2below, at 50% relative power, the low frequency band exhibitedan amplitude of −65 dBV while the maximum amplitude megasonic frequency (600 kHz) exhibited −30 dBV. The corresponding ratio is therefore, (−30 dBV)/(−65 dBV) or 1/2.2, slightly less than 1/2. Similarly, at 70% or 100% relative power levels, the corresponding ratio was found to be (−10 dBV)/(−60 dBV) or approximately 1/6. Accordingly, in certain embodiments, this ratio can be 1/2 or less, 1/2.5 or less, 1/3 or less, 1/4 or less, 1/5 or less, or 1/6 or less.

Other embodiments describe an apparatus for cleaning surfaces comprising at least one narrow bandwidth megasonic transducer, said apparatus, exhibiting a maximum delivered power amplitude of at least −50 dBV at megasonic frequency of at least 400 kHz and power amplitudes less than −55 dBV over a low frequency band of 20-360 kHz.

In certain embodiments, this apparatus is adapted for cleaning surfaces or semi-conductor substrates, microelectronic substrates, nanodimensioned substrates, nanostructured substrates, or other similar articles. Those articles containing features which are otherwise prone to damage from ultrasonic cleaning are especially suited for this technology.

Such an apparatus may be configured so as to allow cleaning either single or multiple (or both) substrates.

In certain other embodiments, the apparatus exhibits a maximum amplitude megasonic frequency of at least 450 kHz, at least 500 kHz, at least 550 kHz, at least 600 kHz, at least. 650 kHz, at least 700 750 kHz, at least 800 kHz, at least 850 kHz, at least 900 kHz, at least 950 kHz, or at least 1000 kHz. The amplitudes associated with such an apparatus, in certain embodiments, can be at least −45 dBV at the maximum amplitude megasonic frequency, at least −40 dBV, at least −35 dBV, at least −30 dBV, at least −25 dBV, at least −20 dBV, at least −15 dBV, or at least −10 dBV, while maintaining the low amplitudes at the lower frequency band.

Certain embodiments describe this low frequency (i.e., sub-megasonic frequency) band as being 20 to 360 kHz, 20 to 200 kHz, 20 to 100 kHZ, 60 to 110 kHZ, or more generally within a range independently bounded at the lower end by 20, 40, 60, 80, 100, 120, or 50 kHz, and at the upper end by 360, 310, 260, 210, 160, or 110 kHz.

Again, it is believed frequencies at the lower end of this range are responsible for damage associated with cavitation, though the invention is not limited to the correctness of this thinking. The invention teaches that, within each of the ranges of interest, the apparatus exhibits power amplitudes at these low frequencies to −55 dBV or less, to −60 dBV or less, to −65 dBV or less, or to −70dBV or less.

In separate embodiments, the apparatus exhibits different levels of power in the megasonic range and in the low frequency band. In one measure of this difference, a power ratio is defined, wherein the ratio of decibel amplitudes, measured in −dBV, exhibited at the maximum megasonic frequency to the mean decibel amplitude, also measured in −dBV, exhibited over the frequency range 20-100 kHz is 1/2 or less. The invention therefore teaches that certain embodiments can be 1/2 or less, 1/2.5 or less, 1/3 or less, 1/4 or less, 1/5 or less, or 1/6 or less.

In other embodiments, the apparatus exhibiting the previously described megasonic and low frequency amplitudes is capable of cleaning surfaces containing delicate features without damaging these features. For example, included in the range of conditions described herein, but not limited to this set of conditions, this invention illustrates that damage-free cleaning can be achieved while delivering a megasonic'frequency in the range of at least 400 MHz at an amplitude of at least −25 dBV.

Other embodiments of this invention relate to cleaning surfaces using any one of the apparatuses or under conditions previously described, wherein the megasonic energy is transmitted through an aqueous, organic, or mixed aqueous-organic solvent system.

In one embodiment, the invention teaches a method of cleaning a surface comprising subjecting said surface to a liquid transmitting at least one narrow bandwidth maximum amplitude megasonic frequency of at least 400 kHz having an amplitude of at least −50 dBV, while maintaining the power amplitudes over the frequency range 20-360 kHz to 55 dBV or less, for a time sufficient to clean the surface.

Such methods also allow cleaning either single or multiple (or both) substrates.

In certain other embodiments, the method of cleaning uses a maximum amplitude megasonic frequency of at least 450 kHz, at least 500 kHz, at least 550 kHz, at least 600 kHz, at least 650 kHz, at least 700 kHz, at least 750 kHz, at least 800 kHz, at least 850 kHz, at least 900 kHz, at least 950 kHz, or at least 1000 kHz.

Further, the amplitudes associated with such methods of cleaning, in certain embodiments, can be at least −45 dBV at the maximum amplitude megasonic frequency, at least −40 dBV, at least −35 dBV, at least −30 dBV, at least −25 dBV, at least −20 dBV, at least −15 dBV, or at least −10 dBV, while maintaining the low amplitudes at the lower frequency band.

Still further embodiments of this method of cleaning describe this low frequency (i.e., sub-megasonic frequency) band as being 20 to 360 kHz, 20 to 200 kHz, 20 to 100 kHz, 60 to 110 kHz, or more generally within a range independently bounded at the lower end by 20, 40, 60, 80, 100, 120, or 150 kHz, and at the upper end by 360, 310, 260, 210, 160, or 110 kHz.

Again, it is believed that frequencies at the lower end of this range are responsible for damage associated with cavitation, though the invention is not so limited. The invention teaches that, within, each of the ranges of interest, the apparatus exhibits power amplitudes at these low frequencies to −55 dBV or less, to −60 dBV or less, to −65 dBV or less, or to −70dBV or less.

In separate embodiments, the method of cleaning uses different levels of power in the megasonic range and in the low frequency band. In one measure of this difference, a power ratio is defined, wherein the ratio of decibel amplitudes, measured in −dBV, exhibited at the maximum megasonic frequency to the mean decibel amplitude, also measured in −dBV, exhibited over the frequency range 20-100 kHZ is 1/2 or less. The invention therefore teaches that certain embodiments can be 1/2 or less, 1/2.5 or less, 1/3 or less, 1/4 or less, 1/5 or less, or 1/6 or less.

Still other embodiments provide that the method of cleaning is adapted to cleaning surfaces of semi-conductor substrates, microelectronic substrates, nanodimensioned substrates, nanostructured substrates, or other similar articles. Those articles containing features which are otherwise prone to damage from ultrasonic cleaning are especially suited to this present method of cleaning.

In certain embodiments these semi-conductor substrates, microelectronic substrates, nanodimensioned substrates, nanostructured substrates, or other similar articles comprise nano-dimensioned structures, wherein these nano-dimensioned structures can defined by processes including lithographically so as to provide nanodimensioned channels and superstructures. It is appreciated by the skilled artisan that certain dimensions can be achieved by use of techniques including optical or electron beam lithography depending on their size. The dimensions of these nano-dimensioned structures have been described above in terms of their cross-sectional dimensions, but include those nano-dimensioned structures wherein the cross-sectional dimension is at least 1, at least 5, at least 10, at least 20, at least 50, or at least 100 nm.

In certain other embodiments, the cleaning is accomplished without damaging the nano-dimensioned structures. As used herein, damage can be physical or electrical, and can be measured by methods including visual inspection, automated optical inspection or electrical interrogation. A structure is not damaged if, by visual or optical inspection, it does not appear to have been altered by the cleaning process or if, by electrical interrogation, the structure maintains at least 80% of its electrical integrity, preferably at least 90%, more preferably at least 95%, and most preferably at least 99% of its electrical integrity. An article i considered “without damage” if at least 80% of the structures are not damaged, preferably at least 90%, more preferably at least 95% and most preferably at least 99% of the structures are not damaged.

In other embodiinents, the semi-conductor substrates, microelectronic substrates, nanodimensioned substrates, nanostructured substrates, or other Similar articles to be cleaned comprise nano-dimensioned channels, wherein said channels are at least 10 nm wide, at least 50nm wide, at least 100 nm wide, or at least 200 nm wide. In some cases, these channels may be as wide as 2 microns.

The invention teaches that it is possible, using the apparatuses and methods described above, to remove at least 20% of the surface debris from the substrate surfaces, preferably at least 50%, more preferably at least 80%, still more preferably at least 90%, and most preferably at least 95% or 99% of the surface debris, including from within the optional nano-dimensioned channels.

In some embodiments, cleaning is accomplished simply using water, preferably deionized water. However, it should be also appreciated that cleaning may be enhanced through use of added chemicals, either in aiding the removal of debris from the surface or inhibiting the redeposition of that debris back to the Surface. Such cleaning chemicals may include an aqueous alkali solution, in aqueous acidic solution, a neutral surfactant solution, an acidic surfactant solution, a basic surfactant solution, an aqueous surfactant solution, or a mixture of organic solvent and water, etc. Aqueous acidic solutions are beneficial for the removal of particulate contamination and trace metals from the surfaces of parts, components, tools, etc. Neutral, acidic, and base surfactant solutions can be used to adjust the surface chemistry on parts, components, tools, etc. to prevent the particles from re-depositing onto the surface of the parts, components, tools. The skilled artisan in this field will be able to modify the chemistries of cleaning without undue experimentation.

In other embodiments, the same conditions provide these levels of cleaning while at the same time providing little or no damage to nano-dimensioned structures attached to the substrates.

This includes those situations where the mean diameter of surface debris 5 nm or higher, 10 nm or higher, 50 nm or higher, or 100 nm or higher.

### EXAMPLES

The following examples are not considered limitations to the scope of the invention but are provided merely to illustrate some of its features.

### Example 1

### Equipment and Test Conditions

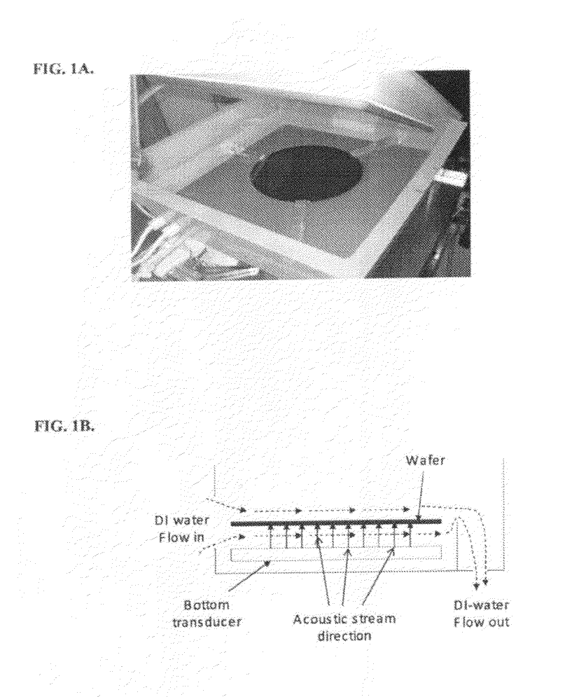

Several commercially available megasonic cleaning tanks were used for the tests. The results were internally consistent with the results described herein, resulting from the use of a NPPD8 megasonic tank Manufactured by PCT Systems, Inc., Fremont Calif. See FIG. 1.

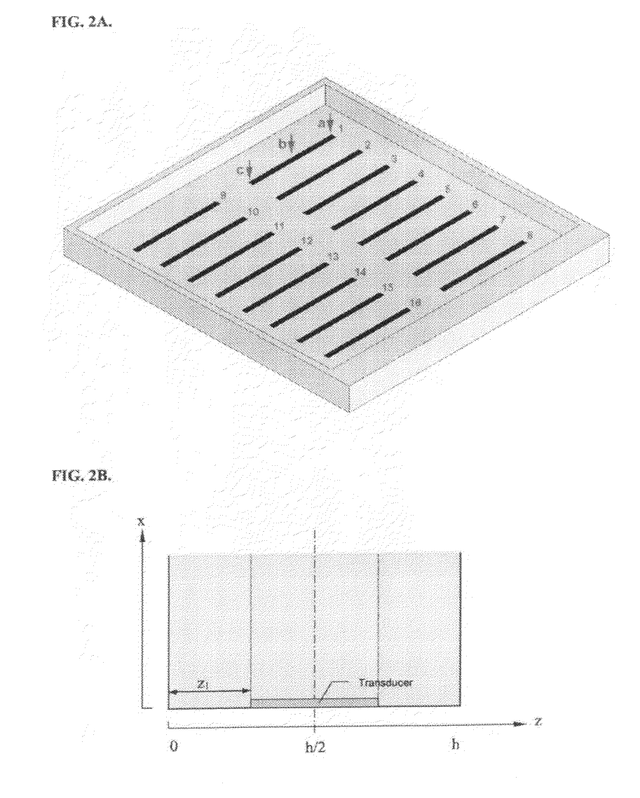

The traditional megasonic system had a rated nominal frequency of 760 kHz. The tank had two arrays of eight transducers (located at the bottom of the tank). See FIG. 2. The Model L2001 frequency probe, available from tm associates, Santa Clara, Calif., used was used from to measure and verify that the operating frequency was indeed 760 kHz frequency. The probe used was along quartz cylinder with ½ inch of diameter; consisting of a sensor that measured the frequency and amplitude (power) generated in the megasonic tank. This was translated into a voltage that changed and fluctuated with the amount of energy generated. The voltage was then displayed as a function of frequency using the L2001 software. The model L2001 ultrasonic probe consists of a sensitive probe, handheld power meter, and an interface box which plugs into the computer and the software to display the reading from the probe.

### Example 2

### Frequency Measurement in Megasonic Tanks

Frequency measurements were conducted at different locations in the megasonic tanks. The measurements were also conducted at several uniformly distributed points along and between transducers as well as various heights above the transducer. The measurements were conducted on top of the active transducer and away from the active transducers for all 16 transducers. Since transducers have a 10 cm length, the measurements took place at 3 different points on the transducers, a, c and b (at the two ends and in the middle of the transducer) as shown in FIG. 2A. This was also repeated for measurements in between the transducers and far from the active transducer. The measurements were also conducted at different heights (¼ inch, ½ inch and 1. inch from the bottom of the tank). Therefore the pressure and frequency were mapped over the whole tank.

Once the frequencies of the commercial tank were mapped, the transducers were replaced with 600 kHz narrow bandwidth transducers, supplied by RESON, Goleta, Calif., and the frequency and pressure measurement tests were repeated using these narrow band megasonic transducers (at 600 kHz). The same measurement procedures used for the traditional transducer were followed for this transducer (on top of the active transducer, away from the active transducer and at different heights). This is done to ensure that this transducer met the narrow band 600 kHz frequency requirement.

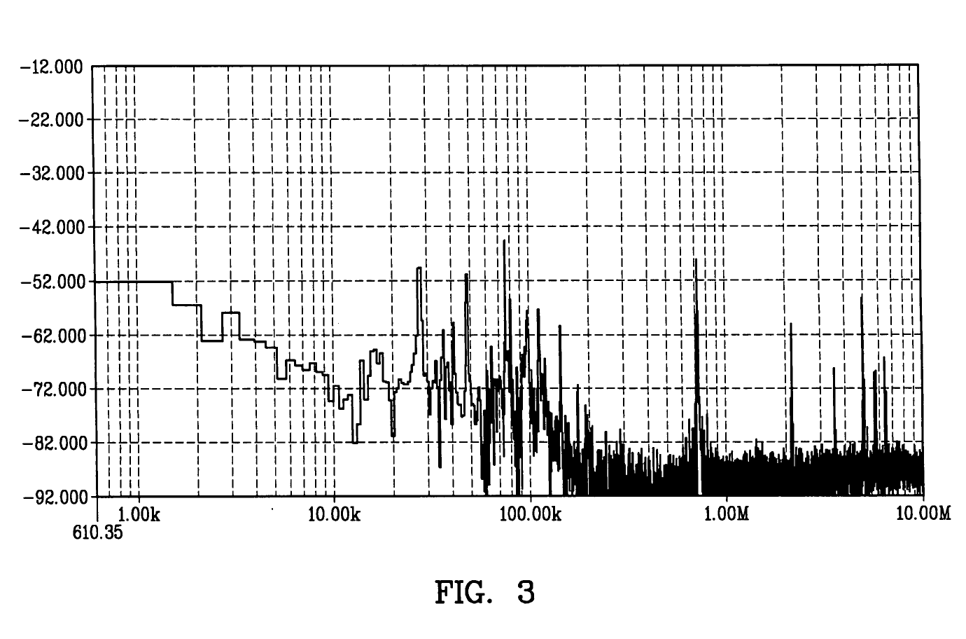

Frequency measurement in the traditional megasonic tank are shown in FIG. 3 where the power versus frequency is displayed when the probe is placed ½ inch above the bottom of the tank and far from the active transducer. The graph also shows that the amplitude at 80 kHz is greater than the amplitude at 760 kHz (which is the operating frequency of the tank).

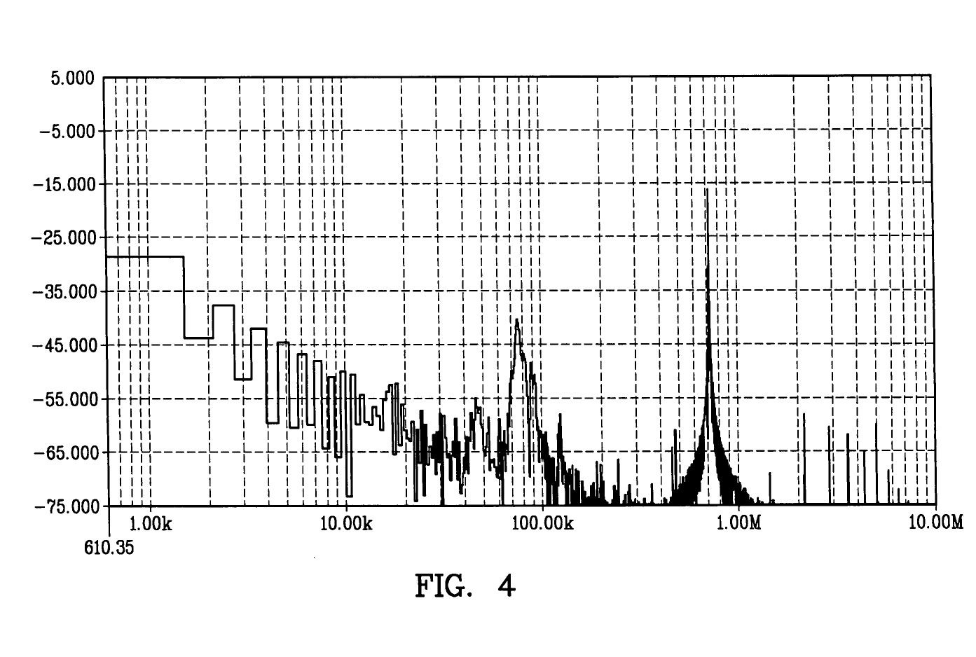

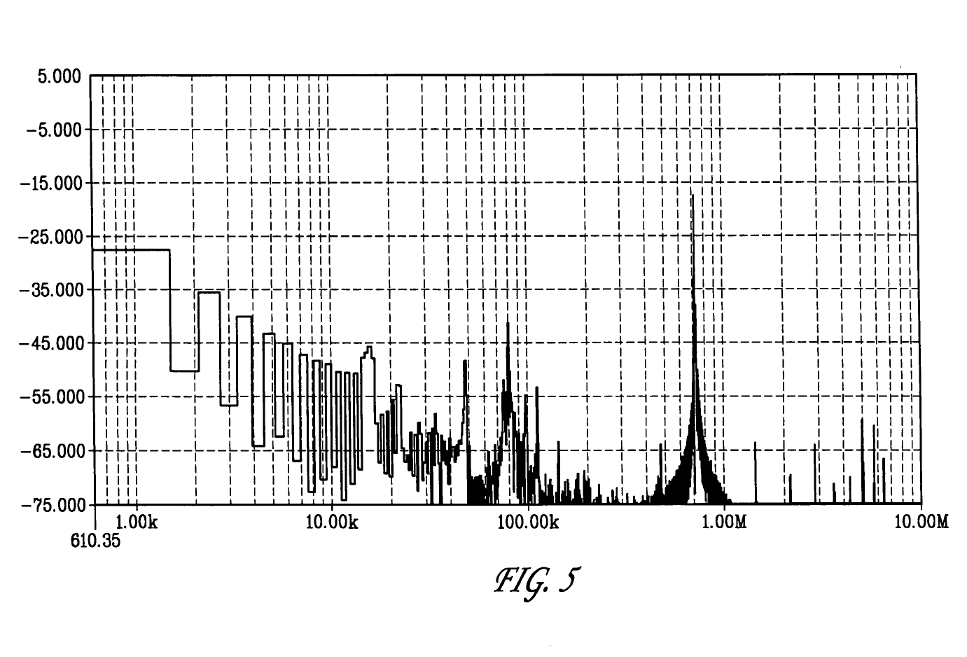

FIG. 4 shows the graph of power versus frequency when the probe is placed ½ inch above the bottom of the tank and on top of the active transducer (the frequency measurement probe is placed on one end of the transducer, point a). Although the peak at 760 kHz is higher than low frequency peaks such as 30 kHz or 80 kHz. The 760 kHz peak is at −15 dBV versus the peak at 80 kHz at −35 dBV. Therefore, these power peaks at such low frequencies are significant enough to cause damage.

FIG. 5 shows one More graph for the same experimental condition that was mentioned for FIG. 4 (the probe is placed ½ inch above the bottom of the tank and on top of the transducer (transducer #4) and in the midpoint of the transducer). These graphs were almost the same for all 16 transducers when the probe is placed at the ends or in the middle of transducer.

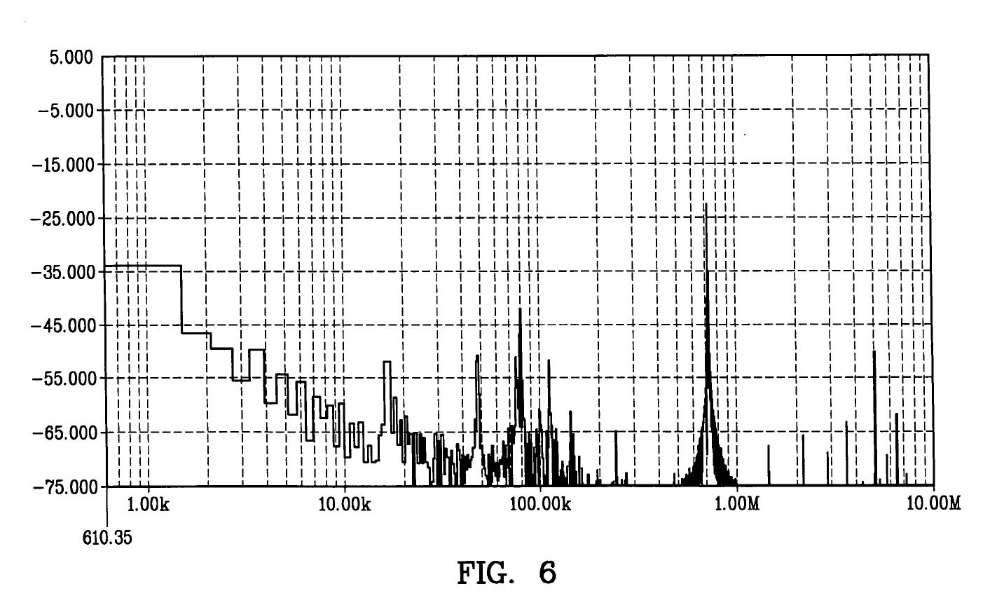

FIG. 6 represents the-frequency measurements when the probe is placed one inch above the bottom of the tank. There were no major differences in frequency or amplitude at different heights.

Equation 1 can be used to convert amplitude to voltage, and compare the ratio of voltages for each of two or more frequencies.

dBV=20 log(V/V_{ref}) (1)

For example in FIG. 3, the amplitude of the low frequency peak was dBV and that of the high frequency peak was −50 dBV. Therefore V₂/V₁ voltage of low frequency peak, V₁; voltage of high frequency peak) was found to be 1.7. That is, the low frequencies were stronger than high frequencies. For the case where the frequency measurement probe is on top of the active transducer, FIG. 4, the ratio of voltages was:

V₂/ V₁=10̂^{(1/20)*(dbV}2−dbV1)=1/17.7 (2)

V₂ voltage of low frequency peak, V₁; voltage: of high frequency peak. When the frequency measurement probe was away from the active transducer the signal from low frequencies are 10 times greater than the case that frequency measurement probe is on top of the active transducer.

FIG. 7 represents the frequency measurement for the narrow bandwidth transducer. As the graph shows the highest peak at low frequencies' signals is −60 dBV and the peak at 600 kHz is −19 dBV.

All the frequency measurement graphs for the traditional single wafer megasonic tank show the presence of low frequencies as well as 760 kHz frequency. FIG. 6 show that the amplitude of the low frequency is comparable to high frequencies and in some cases like FIG. 3 the amplitude of low frequencies is greater than high frequencies. These results were true all over the tank and not just at isolated spots in the tank. As mentioned before, low frequencies in ultrasonics causes cavitation which results in structural damage. The existence of high amplitude low frequencies is verified by these measurements in a typical megasonic tank. These results confirm that cavitation in current megasonic tanks is a result of low frequencies. On the other hand, all the frequency measurements for the narrow bandwidth transducer show no low frequency signal FIG. 7. Therefore, cavitation will not occur in the narrow band megasonic tank.

### Example 3

### Fabrication of Nano-Dimensioned Trenches in Silicon

In order to study the cleaning of particles form structures, nano site trenches in silicon were made. The size of the trenches varies from 200 nm to 2 micron. All trenches have the aspect ratio of one. Trenches are at 9 different locations on the samples and each location consisted of 80 to 100 parallel arrays of trenches. These trenches were fabricated using optical or electron beam lithography depending on their size. Trenches with widths of 2 μm were fabricated using Shipley 1818 photoresists and optically exposed. Trenches with submicron widths were created using 3.5% Polymethylmethaerylate (PMMA) diluted in anisole (3:1) and exposed using e-beam.

Since particle removal efficiency depends on the roughness of the walls or bottom of the trenches, particular care was made to make the walls and bottom of the trenches smooth (roughness affects the adhesion between the particles and surface, depending on the size of the particle and the roughness tolerances. If the size of the particle is more than the roughness, the adhesion decreases so the particles will be removed easily. In the other hand, if the particle gets trapped in the valleys of the rough surface, removing the particles is harder).

To make 2 micron trenches in silicon, photo resist 1818 was spin coated on a 3 inch wafer and baked at 115° C. Optical lithography was used to make the patterns. The samples were developed and etch by using ICP. Oxygen and SF6 were the gases used in the etching process. Several etching tests were done to find out the correct ICP condition which results in getting smooth and straight walls.

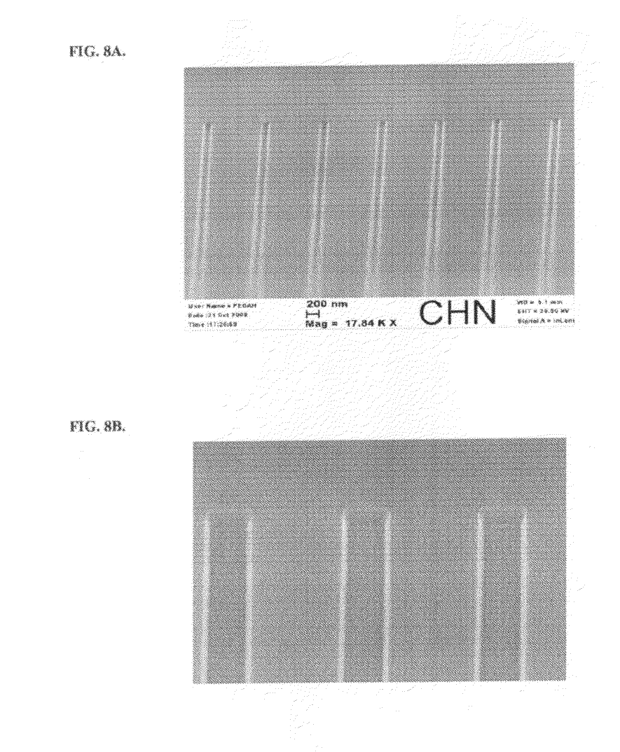

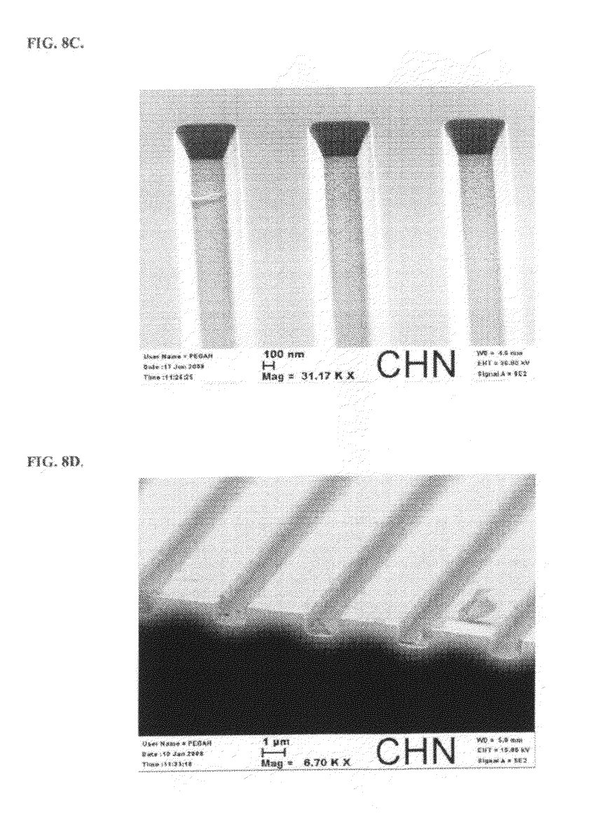

To fabricate 800, 500 and 200 nm trenches in silicon, a silicon chip which had a layer of grown oxide with a thickness of 45 nm on top was used. PMMA was spin coated on top of a process chip with a thickness of 150 nm. The PMMA was baked at 180° C. for 90 seconds. For all the samples e-beam lithography was used to write the patterns. The process chip was developed in solution of methyl isobutyl ketone/isopropanol 1/3 (MIBK/IPA) for 70 seconds at room temperature, followed by IPA for 20 seconds. E-beams, followed by selective ICP etching, first with CF₄, then with oxygen and SF₆, was used to pattern and etch the silicon and provide the desired trenches. Trenches with widths of 200 nm, 500 nm, 800 nm and 2 μm and an aspect ratio of one were fabricated. FIGS. 8A-D, show the SEM images of silicon trenches.

### Example 4

### Cleaning Efficiency of Polystyrene Latex (PSL) Particles

To determine the effect cleaning efficiency as a function to power, the cleaning performance of the two transducers has to be also compared, comparing the removal efficiency of 100 nm polystyrene latex (PSL) particles from a flat silicon substrate using both tanks.

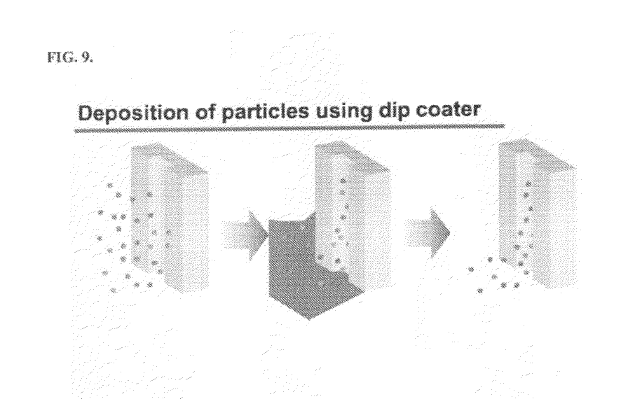

Red fluorescent PSL (100 nm) were suspended in deionized water. Several drops of particle solution were poured on the silicon chip, selectively depositing the particles within the trenches only using a dip coater (see. FIG. 9). In order to deposit particles, the samples were cleaned using piranha solution (sulfuric acid and hydrogen peroxide=3:1) for 10 minutes, left to dry in the clean room for 2 hours. The Red fluorescent PSL particles (suspended in deionized water) are then deposited (or assembled) using capillary force inside trenches on the prepared samples utilizing a dip coater. The size distribution: for 100 nm particle was 97±3 nm and for 200 nm particle was 200±6 nm.

Particles were counted before and after cleaning using Nikon Optiphot 200D microscope equipped with a fluorescent attachment. The microscope is equipped with a standard halogen lamp for optical microscopy and a Xenon arc lamp for fluorescent microscopy. The samples were cleaned sequentially in the traditional megasonic tank and the narrow bandwidth megasonic cleaning tank with different powers (100%, 70%, 50% and 30% of nominal power).

Particles were counted before and after cleaning using a Nikon Optiphot 200D mieroscope equipped with a fluorescent attachment. The microscope is equipped with a standard halogen lamp for optical microscopy and a Xenon arc lamp for fluorescent microscopy. After focusing on the trenches using the bright field mode, the microscope was switched to the dark field Mode and PSL particles excited using the fluorescent attachment In this mode, the particles appeared as red dots on a black background. Using Image pro-pus software, particles inside the trenches were counted before and after cleaning. The observed particle image ratio was monitored during the counting of particles before and after cleaning to prevent counting of agglomerated particles. The viewed area for all tests was exactly the same. The initial particle count before cleaning was approximately 300 particles in the viewed area. The remaining particles in the same viewed area are counted after cleaning. When smaller trenches are used, the same viewing area is used, resulting in larger number of trenches.

This nanoparticle counting technique using fluorescent microscopy was also verified using SEM imaging. SEM images of nanoparticles within the trenches were compared with fluorescent images at the same location.

A single wafer megasonic tank operating at 760 kHz with a maximum power output of 640 W (intensity of 7.75 W/cm²) was employed for the cleaning experiments. The samples were cleaned within 30 minutes after particle deposition. Since particle adhesion induced deformation occurs after 4 or more hours, these particles were not affected by it.

All cleaning experiments were done using deionized water. The effect of megasonic power was investigated in the removal of 100 nm PSL particles with 100% 75% and 50% power and 200 nm PSL particles with 60% and 30% power. In addition, the effect of time in the removal of both 100 nm and 200 nm PSL particles was also investigated. The cleaning time was varied from 1 to 8 minutes.

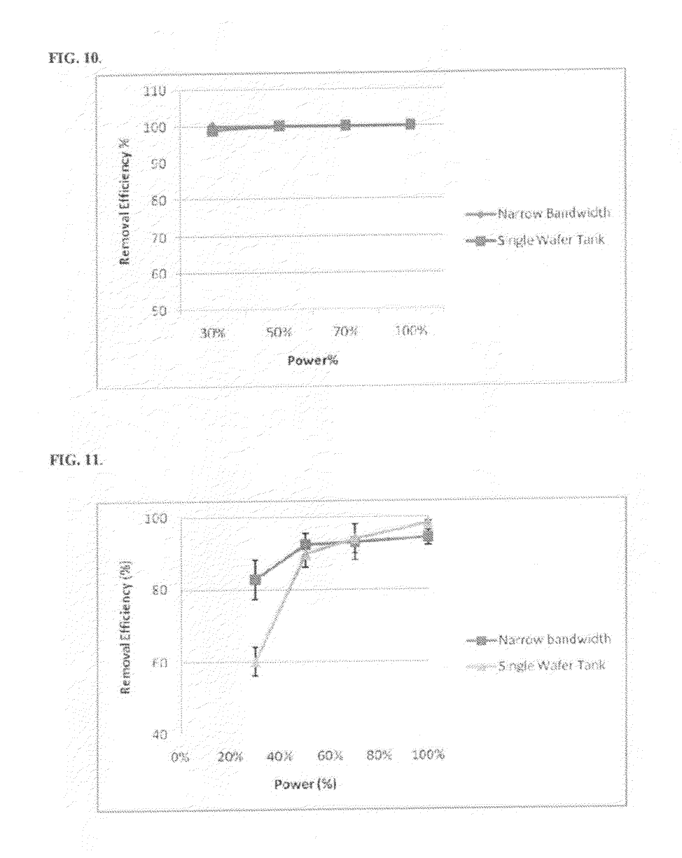

FIG. 10 shows the removal efficiency of 100nm PSL particles from flat silicon substrates. The 100 nm PSL particles are deposited on the substrate and are cleaned within 30 minutes. The results show a 100% removal efficiency for both megasonic single water tank and narrow bandwidth transducer. In this case, a more challenging cleaning test is needed to differentiate and challenge both megasonic tanks.

### Example5

### Cleaning Efficiency of Aged Polystyrene Latex (PSL) Particles

In a more discriminating test, a second set of cleaning efficiency experiments was done using 100 nm PSL particles on a flat silicon substrate which are aged in the clean room (for 7 hours after spinning and drying). The aging was done to increase the adhesion induced deformation effect and consequently the adhesion force of the particles to the substrate, providing a more challenging cleaning test for both tanks.

The removal efficiency of aged 100 nm PSL particles (aged for 7 hours) from the surface of silicon chips is shown in FIG. 11. The figure show that the cleaning performance is equivalent (within the standard deviation).

### Example 6

### Cleaning Efficiency of Aged Silicon Nitride Particles

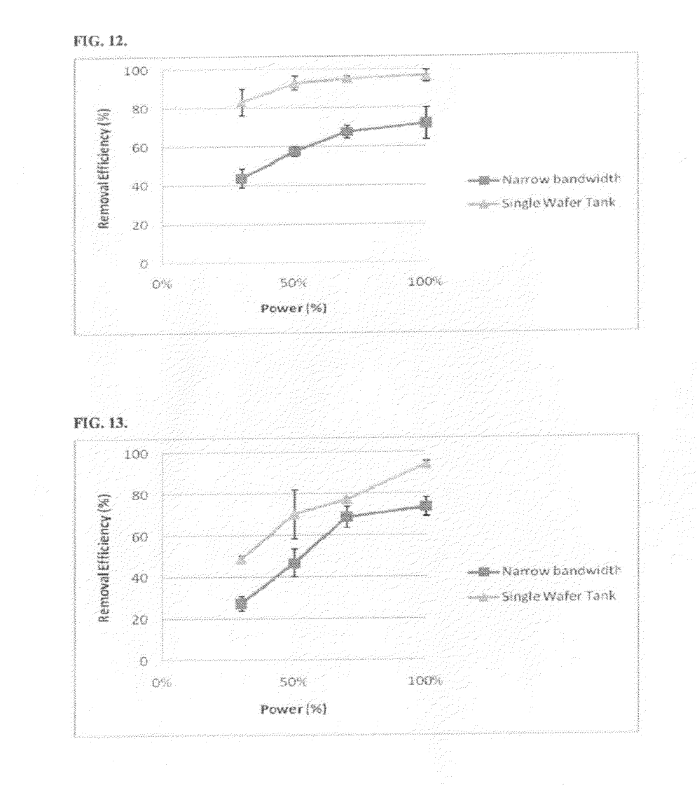

Additional experiments were conducted in order to have a better understanding of particle removal performance. Since silicon nitride particles are harder to remove than PSL particles, these experiments were done using different size silicon nitride particles. Two size silicon nitride particles were used for these experiments, 300 nm and 600 nm silicon nitride particles were suspended in deionized water. The particle solution was deposited on 6 inch silicon wafers using a spinner. Samples were cleaned in both traditional megasonic tank and narrow bandwidth megasonic tank. Samples were cleaned for 4 minutes at the different megasonic powers. The number of particles were counted by surface scanner before and after the cleaning to find out the particle removal efficiency. FIG. 12 shows removal efficiency of 600 nm particles at 4 different megasonic powers.

FIG. 13 shows the removal efficiency of 300 nm silicon nitride particle at four different megasonic power. The results show the removal efficiency of narrow band megasonic (600 kHz) is lower than traditional megasonic (760 kHz) at the same power. This is due to the fact that removal efficiency increases as megasonic frequency increases.

### Example 7

### Damage as Function of Megasonic Energy

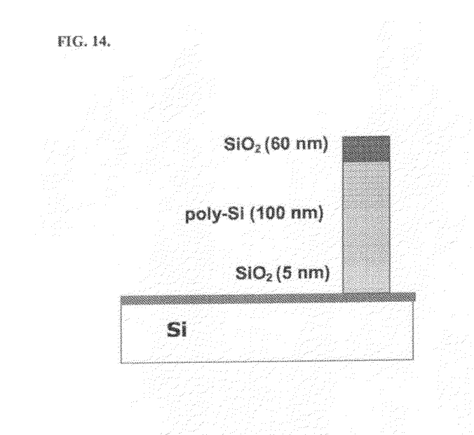

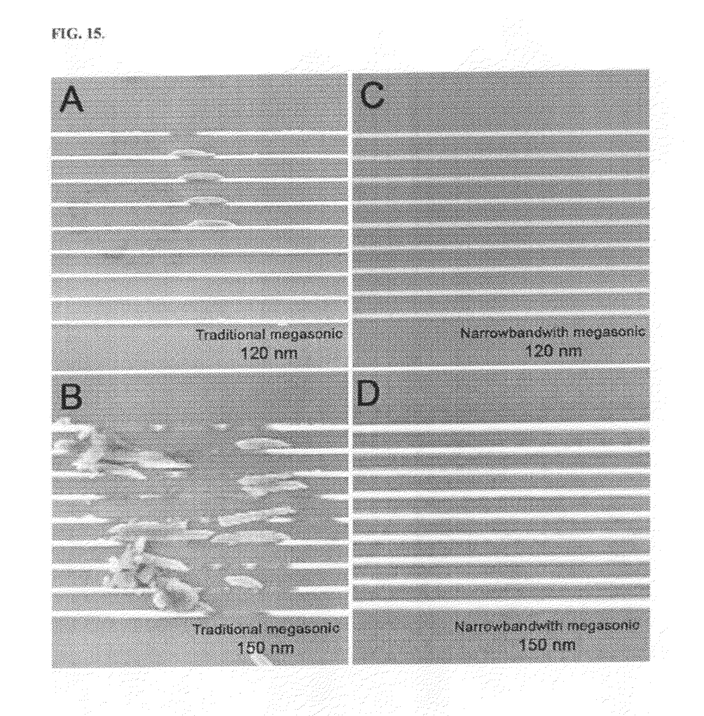

Following the investigation of the cleaning performance of the traditional megasonic tank and the narrow bandwidth megasonic, damage experiments were conducted. The damage experiments were conducted at the different powers (100%, 70%, 50% and 30% power) for both tanks. Samples for the damage experiments were 1 cm×2 cm chips that had structures of different scales. The structures were walls with widths that varied between 50 nm to 30 micron and the ratio of the walls to pitch varied from 1:1 to 1:5. See FIG. 14. Samples were cleaned in both tanks for 5 minutes for each power setting. Samples were then inspected using a field emission scanning electron microscope (FESEM) before and after each cleaning experiment.

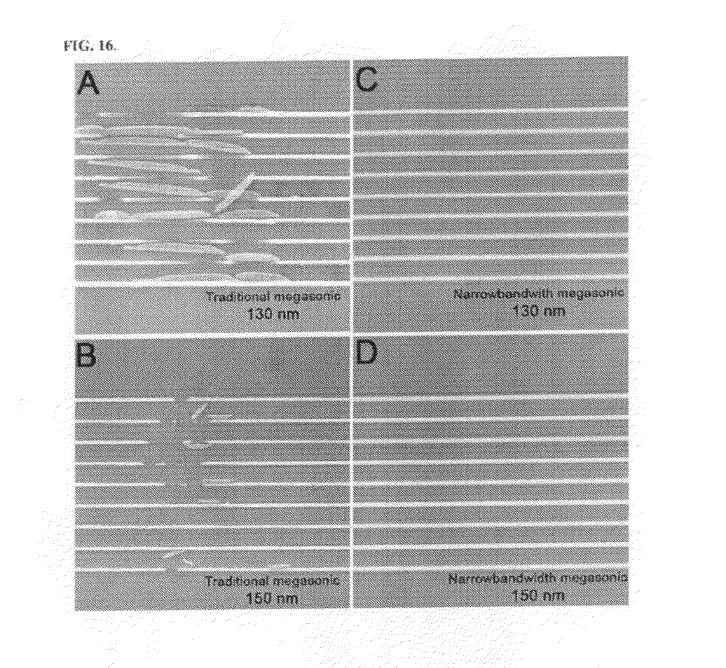

Possible structural damage of polysilicon structures was investigated at different powers for both tanks. FIG. 15 shows the comparison between single wafer tank and narrow bandwidth transducer with both tanks operating at 30% of their power. Images on the left side were cleaned using the traditional megasonic single wafer tank for 5 minutes. The two images shown were from two different locations of the same sample. The right side shows the images of the sample cleaned by the narrow band width transducer for the same amount of time. While the samples cleaned by traditional megasonic single wafer tank showed extensive damages, those cleaned using the narrow band megasonic transducer showed no damage.

The left side of FIG. 16 shows the SEM images of samples cleaned by megasonic with 50% of the power. Both 130 nm and 150 nm lines cleaned by the traditional megasonic frequencies have been damaged. None of the samples cleaned by narrow bandwidth transducer showed any damage anywhere on the sample.

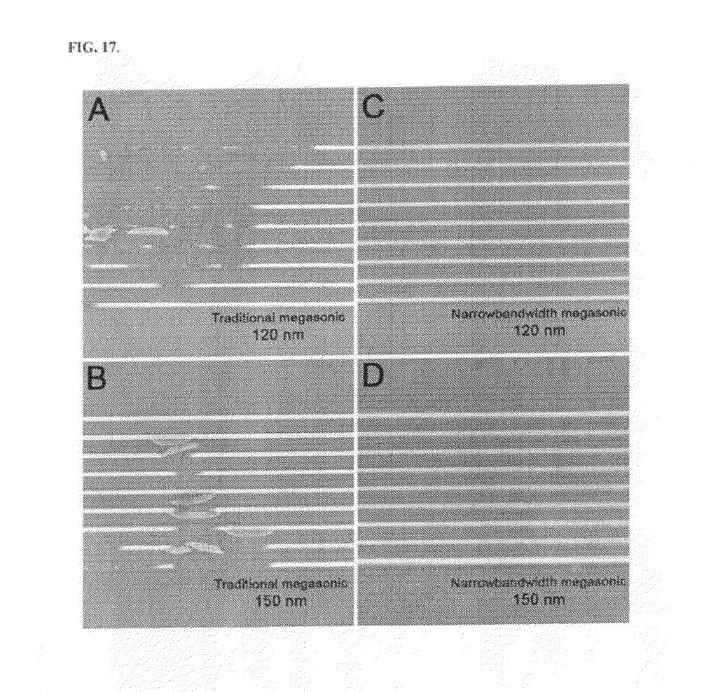

FIG. 17 shows the SEM images of samples cleaned by both tanks at 70% of their power. The left side (A and B) show images from two different samples cleaned by the traditional megasonic single wafer tank. The right side (C and D) shows images of samples cleaned by narrow bandwidth transducer. All the samples were cleaned for the same amount of time (5 minutes). Again, the arrow bandwidth cleaned samples showed no damage at 70% power as compared to the traditional tank which still showed significant damage.

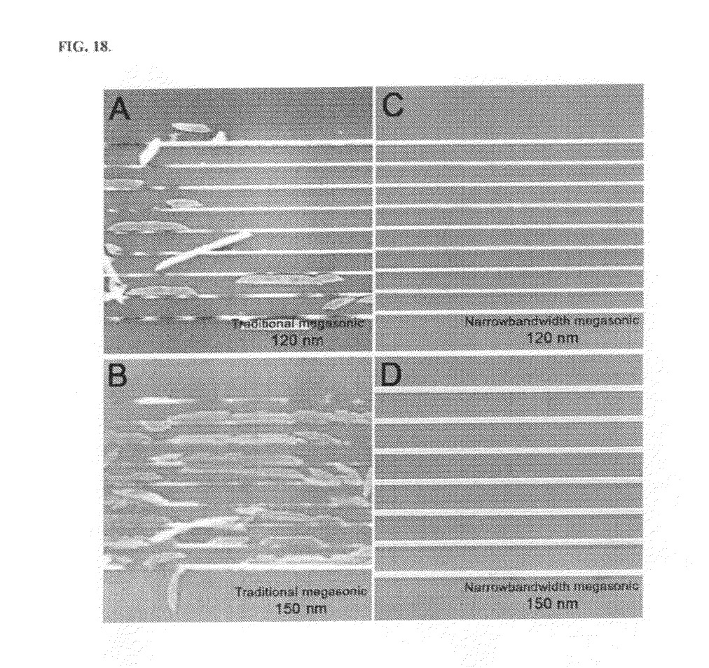

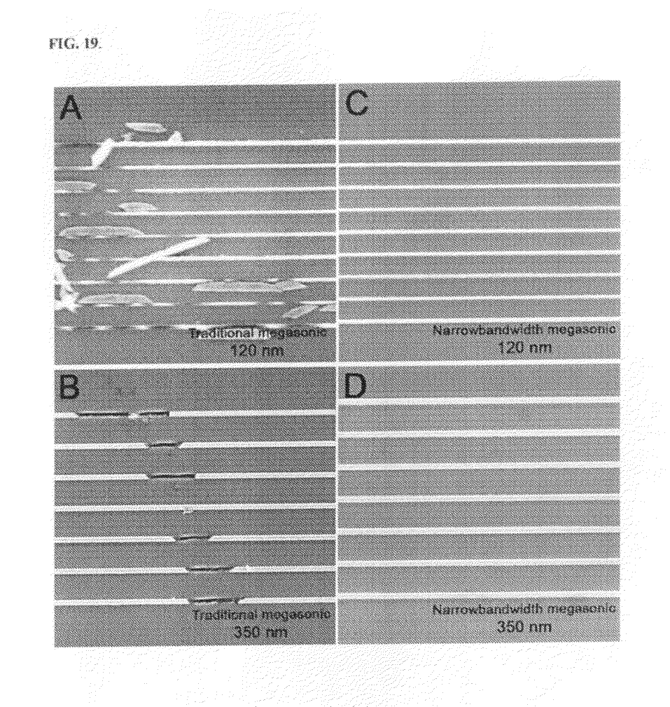

FIG. 18 represents the SEM images of two samples cleaned by both tanks. The tanks are operating at 100% of their power. The result are the same as 30%, 50% and 70% power. Samples cleaned by the traditional single wafer megasonic tank had damage at all power setting where the narrow bandwidth transducer showed no damage.

FIG. 19 shows the SEM images of even larger lines, showing the constancy of the observations.

As the power matching experiments results shows, the cleaning performance of both tanks is equivalent. As the SEM images show, structures were damaged at all power setting of the traditional megasonic tank while there was no damage on any samples that were cleaned at 100% power of narrow bandwidth transducer.

### Example 8

### Damage as a Function of Megasonic Energy

Another set of experiments was done in an attempt to understand the threshold low-frequency energy necessary to cause damage to 120 nm structures. The data, presented in Tables 1 and 2 suggest that avoiding damage to nanodimensioned structures requires that the amplitudes of the low frequencies must be lower than −55 dBV. It is possible that even finer structures will be susceptible to damage as even lower amplitudes.

TABLE 1
Damage as a function of relative power/measured low
frequency amplitude using traditional megasonic cleaning
frequency at 760 kHz

| Relative | Low Frequency | dBV of Low | dBV of Megasonic | Damage |
|---|---|---|---|---|
| Power | Range, kHz | Frequency | Frequency | (Y/N) |
| 10% | 20 to 100 | (−50) to (−40) | (−55) to (−35) | N/A |
| 30% | 20 to 100 | (−50) to (−45) | (−50) to (−25) | Yes |
| 50% | 30 to 100 | (−55) to (−45) | (−50) to (−25) | Yes |
| 70% | 50 to 100 | (−55) to (−40) | (−55) to (−20) | Yes |
| 100% | 20 to 110 | (−55) to (−35) | (−55) to (−15) | Yes |

TABLE 2
Damage as a function of relative power/measured low
frequency amplitude using narrow band megasonic cleaning
frequency at 600 kHz

| Relative | Low Frequency | dBV of Low | dBV of Megasonic | Damage |
|---|---|---|---|---|
| Power | Range, kHz | Frequency | Frequency | (Y/N) |
| 30% | 60 to 100 | (−65) | (−50) to (−40) | No |
| 50% | 60 to 100 | (−65) | (−40) to (−30) | No |
| 70% | 70 to 100 | (−65) to (−60) | (−35) to (−10) | No |
| 100% | 60 to 110 | (−65) to (−60) | (−35) to (−10) | No |

As those skilled in the art will appreciate, numerous modifications and variations of the present invention are possible in light of these teachings, and all such are contemplated hereby. For example, in addition to the embodiments described herein, the present invention contemplates and claims those inventions resulting from the combination of features of the invention cited herein and those of the cited prior art references which complement the features of the present invention. Further, to the extent that the descriptions provided for the cleaning apparatuses are not specifically reflected in the descriptions for the methods of cleaning, it should be readily apparent that these are considered to be within the scope of the latter and vice versa. Similarly, it will be appreciated that any described material, feature, or device may be used in combination with any other material, feature, or device, so as to provide a flexible toolkit of options.

The disclosures of each patent, patent application, and publication cited or described in this document are hereby incorporated herein by reference, in their entirety.

What is claimed:

1. An apparatus for cleaning surface debris from a surface comprising at least one narrow bandwidth megasonic transducer providing a power amplitude of at least −50 dBV at a maximum amplitude megasonic frequency of at least 400 kHz while providing power amplitudes of −55 dBV or less over a low frequency band between 20 and 360 kHz.

2. The apparatus of claim 1 adapted for cleaning surfaces of semi-conductor substrates, microelectronic substrates, nanodimensioned substrates, or nanostructured substrates.

3. The apparatus of claims 1 or 2 comprising at least one narrow bandwidth megasonic transducer providing a power amplitude power at a maximum amplitude megasonic frequency of at least 600 kHz.

4. The apparatus of claim 3 comprising at least one narrow bandwidth megasonic transducer providing a power amplitude power at a maximum amplitude megasonic frequency of at least 700 kHz.

5. The apparatus of claim 4 comprising at least one narrow bandwidth megasonic transducer providing a power amplitude power at a maximum amplitude megasonic frequency of at least 800 kHz.

6. The apparatus of any one of claim 1-5, comprising at least one narrow bandwidth megasonic transducer providing a power amplitude of at least −30 dBV at the maximum amplitude megasonic frequency.

7. The apparatus of claim 6 comprising at least one narrow bandwidth megasonic transducer providing a power amplitude of at least −10 dBV at the maximum amplitude megasonic frequency.

8. The apparatus of any one of claims 1-7, wherein the low frequency band is in the range of 20 to 200 kHz.

9. The apparatus of claim 8, wherein the low frequency band is in the range of 40 to 160 kHz.

10. The apparatus of any one of claims 1-9, wherein the power amplitudes over the low frequency band are −60 dBV or less.

11. The apparatus of claim 10, wherein the power amplitudes over the low frequency band are −65 dBV or less.

12. The apparatus of claim 1 comprising at least one narrow bandwidth megasonic transducer providing a power amplitude of at least −35 dBV at a maximum amplitude megasonic frequency of at least 600 kHz while providing power amplitudes of −60 dBV or less over a low frequency band between 20 and 1.00 kHz.

13. The apparatus of anyone of claims 1-12 wherein the ratio of decibel amplitudes, measured in −dBV, of the maximum amplitude megasonic frequency to the mean decibel amplitude, also measured in −dBV, of the low frequency band of 20-100 kHz is 1/2 or less.

14. The apparatus of claim 13 wherein the ratio of decibel amplitudes is 1/3 or less.

15. The apparatus of claim 14 wherein the ratio of decibel amplitude is 1/6 or less.

16. An apparatus for cleaning surface debris from a surface comprising at least one narrow bandwidth megasonic transducer, said apparatus exhibiting a maximum delivered power amplitude of at least −50 dBV at a maximum amplitude megasonic frequency of at least 400 kHz while exhibiting power amplitudes of −55 dBV or less over a low frequency band 20-360 kHz.

17. The apparatus of claim 16 adapted for cleaning surfaces of semi-conductor substrates, microelectronic substrates, nanodimensioned substrates, or nanostructured substrates.

18. The apparatus of claim 16 or 17, said apparatus capable of cleaning a lithographically nanodimensioned patterned substrate, without damaging the substrate, while delivering a megasonic frequency in the range of at least 400 MHz at an amplitude of at least −35 dBV.

19. A method of cleaning surface debris from a surface comprising subjecting said surface to a liquid transmitting at least one narrow bandwidth maximum amplitude megasonic frequency of at least 400 kHz having an amplitude of at least −50 dBV, while maintaining the power amplitudes over the frequency range 20-360 kHz to −55 dBV or less, for a time sufficient to clean the surface.

20. The method of claim 19 wherein the surface is that of a semi-conductor substrate, microelectronic substrate, nanodimensioned substrate, or nanostructured substrate.

21. The method of claim 20 wherein the substrate comprise nano-dimensioned structures.

22. The method of claim 21, wherein the nano-dimensioned structures have cross-sectional dimensions in the range of 5 nm to 1000 nm.

23. The method of claim 22, wherein the nano-dimensioned structures have cross-sectional dimensions in the range of 100 nm to 500 nm.

24. The method of any one of claims 21-23 wherein the nano-dimensioned structures are not damaged by the cleaning.

25. The method of any one of claims 19-24 wherein the substrate comprises channels.

26. The method of claim 25, wherein the channels are 50 nm wide or wider.

27. The method of any one of claims 19-26 wherein the time and energy is sufficient to remove at least 50% of the surface debris from the substrate.

28. The method of any one of claims 19-27 wherein the mean diameter of the surface debris is 5 nm or higher.

29. The method of claim 28 wherein the mean diameter of the surface debris is 50 nm or higher.
